(19) United States
(12) Patent Application Publication
(10) Pub. No.: US 2011/0065428 A1
(43) Pub. Date: Mar. 17, 2011

(54) SYSTEMS AND METHODS FOR SELECTING AN OUTPUT MODALITY IN A MOBILE DEVICE

(75) Inventor: Horst J. Schroeter, New Providence, NJ (US)

(73) Assignee: AT&T INTELLECTUAL PROPERTY I, L.P, Reno, NV (US)

(21) Appl. No.: 12/560,650

(22) Filed: Sep. 16, 2009

(51) Int. Cl. H04M 3/00

(52) U.S. Cl. 455/418

(57) ABSTRACT

A method and system for selecting the output modality of an application in a mobile device from attributes of the mobile device includes a detection of at least one attribute of the mobile device, automatically identifying available modalities for the output of the application based on the attribute, and selecting a preferred output modality from the available modalities. The output of the application is converted to the output modality and transmitted through an output interface selected based on the attributes measured.

### TECHNICAL FIELD

The present invention relates to systems and methods selecting an output modality in a mobile device. More particularly, the present invention relates to systems and methods for determining and implementing the selection of voice, visual, text, hepatic or other modalities for the output signal of an application in a mobile device based on attributes, such as speed, input interfaces, type of application, and coupling of a peripheral devices detected or measured by the mobile device.

### BACKGROUND

The development of wireless technology has enabled users to operate a variety of devices, including laptop computers, handheld computers, personal digital assistants, cell phones and smart phones, and other mobile devices while on the move. Applications used in these mobile devices vary widely and include for example access to the internet, entertainment applications, GPS enabled navigation, games, search tools, productivity tools and others.

These mobile devices enable the users to interface with the applications through a variety of input and output interfaces using one or more modalities. Example of input interfaces include keyboards, touch screens, voice, point and click, infrared signals, mouse devices and wireless interaction. Examples of output interfaces may include display screens, audio, heads up displays, and hepatic technologies (e.g. vibrations). The modalities of the output interfaces may include sound (aural), visual and hepatic.

There are a number of situations where one output modality may be preferred over another output modality. The most notable example is when the user is driving. Drivers that input telephone numbers or text messages into a mobile device while driving have a much higher incidence of accidents. Some states have made hand held cell phone use illegal while operating a motor vehicle. Unfortunately, many users forget to change the input interface and the output modalities of their mobile device when the circumstances of use change. The user may be carrying a cell phone from their office to their car and forget to change the input interface to speech recognition and the output interface to a speakerphone, thereby enabling hands off operations. If a user wants to make a call while the user is driving the natural tendency is to pick up the phone in a handheld fashion. Sometimes a user is driving and suddenly remembers a phone call or e-mail that the user needed to make or send. The user may need to query a directory in the mobile device to acquire the phone number or e-mail address. The user is likely to pick up the mobile device and key in the query and look at the mobile device display to see the results of the query. These actions place the user and others at risk of an accident.

The safety issue may be exacerbated when the user is attempting to interact with other applications in the mobile device while driving. For example, some mobile devices include applications that provide turn by turn GPS navigation. The user inputs the destination address and the application in conjunction with the GPS capability instructs the driver how to navigate to the destination. The output of the application may be presented graphically or aurally or both. If the user is driving it is safer to provide the capability of providing the input aurally rather than by touch screen or keyboard input. Similarly it may be desirable to provide the output aurally rather than through a graphical display. Many of these applications have the capability of identifying nearby locations (for example, gas stations, restaurants and the like). In many cases the applications display the nearby locations as a list on the mobile device display and allows the user to select one as a destination. To do this, a user that is driving would have to take their eyes off the road thereby increasing the risk of an accident.

Other types of applications where it would be desirable to automatically select the output modality of the mobile device may include the access to certain web pages. For example, a user may desire to access a weather or traffic site while driving. Again, it would be much safer if the output (the content of the web page) were provided aurally rather than in the mobile device display.

Thus there is a need for improved systems and methods to automatically select the input and output modality of a mobile device based on certain measurable attributes of the mobile device.

### SUMMARY

Broadly speaking, the invention relates to methods for automatically selecting the input and output modalities of a mobile device based on certain detectable or measurable attributes of the mobile device. More specifically, in one embodiment of the invention, a method for automatically selecting the modalities of an output signal for an application of a mobile device is provided by initiating an application in the mobile device, providing an input, detecting or measuring an attribute of the mobile device and automatically selecting an output modality based on the values of the measured attribute. The output of the application is then converted to the selected output modality and communicated to the user.

In another embodiment a mobile devices provided with a component for detecting or measuring an attribute, a means for selecting an output modality based on the value of the detected or measured attribute, means for converting the output of an application to the selected output modality and means for communicating to the user the output of the application in a selected output user interface and in the selected output modality.

### BRIEF DESCRIPTION OF THE DRAWINGS

The foregoing summary, as well as the following detailed description of illustrative embodiments, is better understood when read in conjunction with the appended drawings. For purposes of illustrating the invention, there is shown in the drawings example constructions of the invention; however, the invention is not limited to the specific methods and instrumentalities disclosed. Various exemplary embodiments of this invention will be described in detail, with reference to the following figures, wherein like numerals represent like elements, and wherein:

FIG. 1 is a block diagram of a non-limiting, exemplary method for selecting an output modality for an application in a mobile device;

FIG. 2 is a block diagram of a non-limiting, exemplary method for selecting an input interface and an output modality for an application in a mobile device;

FIG. 3 is a block diagram of a non-limiting, exemplary method for selecting an output modality for a Web search application in a mobile device;

FIG. 4 is a block diagram of a non-limiting, exemplary method for selecting an input interface and output modalities for an application in a mobile device when the attributes change over time;

FIG. 5 is an illustration of a system for selecting a modality of an application in the a mobile device based on a detected or measured attribute;

FIG. 6(a) is an illustration of a system for selecting a modality of an application of a mobile device using the spatial orientation and contact point of the mobile device as the measured attributes;

FIG. 6(b) is another illustration of a system for selecting a modality of an application of a mobile device using the spatial orientation of the mobile device as the measured attribute;

FIG. 7 is an illustration of a system for selecting a modality of an application of a mobile device using detection of a peripheral component such as a Bluetooth headset connected to mobile device as the measured attribute;

FIG. 8 is a block diagram of a non-limiting, exemplary wireless device that may be used in connection with an embodiment.

FIG. 9 is a block diagram of a non-limiting, exemplary processor in which the present subject matter may be implemented.

FIG. 10 is an overall block diagram of an exemplary packet-based mobile cellular network environment, such as a GPRS network, in which the present subject matter may be implemented.

FIG. 11 illustrates a non-limiting, exemplary architecture of a typical GPRS network as segmented into four groups.

FIG. 12 illustrates a non-limiting alternate block diagram of an exemplary GSM/GPRS/IP multimedia network architecture in which the present subject matter may be implemented.

### DETAILED DESCRIPTION OF ILLUSTRATIVE EMBODIMENTS

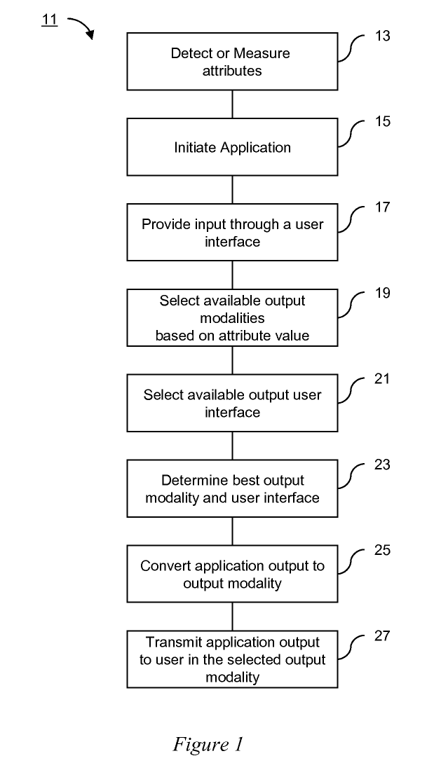

FIG. 1 illustrates a method 11 for automatically selecting the output modality of a mobile device application. The mobile device detects or measures (step 13) an attribute of the mobile device. As used herein, an attribute is a characteristic, quality or state of a mobile device that can be detected or measured. There are a variety of attributes that can be detected or measured. For example, one attribute may be whether a microphone has been attached to the device. Another attribute may be whether the mobile device is being held against the ear of the user. Yet another attribute may be whether the phone is being held in front of the user (typical when using the mobile device in speakerphone mode). Another attribute may be a detection of the input interface selected by the user for the application (for example, keyboard typing, touch screen selection, voice commands). Another attribute may be whether a headset (wired or Bluetooth) is attached to the mobile device. Yet another attribute may be the location, the velocity, or both location and velocity of the device. Yet another attribute may be the noise or light level environment of the mobile device. Again, the number of attributes of the mobile device that can be detected or measured are numerous, and the foregoing are just examples of the type of attributes that can be detected or measured in accordance with the method illustrated in FIG. 1.

The user of the mobile device initiates an application (step 15) in the mobile device. Typically the initiation of the application is done by selecting an application on the mobile device and providing a start instruction, for example, by touching an icon on a touch screen, or clicking a click wheel on the device when an icon is selected. Other ways of starting an application may be entering a command on a keyboard of the mobile device or providing a start instruction with a voice command. Examples of applications include directory applications, navigation applications, directory assistance (411), web searches and the like.

The user provides an input to an application in the mobile device through a user interface (step 17). For example, the input user interface may include a keyboard, a touch screen, a voice recognition system and the like. In a GPS navigation application, the user may utilize a keyboard to input the destination address. Alternately, in some mobile devices, the user may use a touch screen with a graphically displayed keyboard to provide the destination address. Yet another way of providing input to the application may be by stating the destination address out loud. Another example of an application where the method illustrated in FIG. 1 can be applied would be a directory database stored in the mobile device having names, phone numbers and addresses associated with the names. In one type of mobile device a display screen displays a plurality of icons each signifying a particular application. Initiation of a directory may be accomplished through the use of a “click-wheel”, by moving the cursor over the directory icon and clicking the click wheel to initiate the application. The directory application would then require an input (e.g. last name), and upon receiving the input the application searches the database for the name and return a directory entry for the person with that name. The numbers of applications that are available in mobile devices is quite large, and the foregoing are just two examples of the types of application in which the method illustrated in FIG. 1 can be applied.

In the next step, the mobile device selects the available output modalities available for the application based on the measured attributes (step 19). For the purpose of the present subject matter modality refers to a user-computer interaction that includes a sense through which the user can receive the output of the computer. Multiple modalities may be available for outputs. The three major modalities utilized in user-computer interactions are vision, aural and hepatic (sense of pressure). For example, if the attribute measured is that the mobile device is moving at a speed greater than 3 mph (walking speed) the available output modality may be aural output (i.e. sound). If the device is moving at a speed greater than 3 mph, it is likely that the mobile device is being used in an automobile, and if the user is the driver, text or graphical displays would not be appropriate because of safety concerns. Similarly, if a headset (wired or Bluetooth) is attached to the mobile device is selected output modality may be aural output to the headset rather than graphical or text. In the next step, available output user interfaces are selected based on attributes value (step 21) and the type of application. Output interfaces may include speakerphone audio, including rendering textual information by a text to speech systems, audio through a headset, audio through a speaker incorporated into the mobile device, a display screen incorporated into the mobile device, pico projection, and the like. The available output user interfaces may include sound output to the headset, and visual output through the display or for pico projection. If no headset is coupled to the mobile device, then available output interfaces may include a built-in speaker in the mobile device, a speaker phone in the mobile device, and visual output through the display.

A modality selection system of the mobile device, in accordance with the present subject matter may include logic to select the best output modality and user interface (step 23), or alternately offer the user a menu of output modalities (in a pre-selected set of output modalities) and user interfaces for the user to select. An example of an implementation of this step may be the situation where the user is in a moving automobile, the application is a Web search, and the input interface is a microphone built into the mobile device. The best output modality may be sound, and the best user interface may be a speaker phone. In another example, if the initiated application is a navigation application, and the attribute measured is speed, and the system determines that the mobile device is moving at a speed of 30 mph, then the output modality of the navigation application would be speech. In this case some of the graphical information usually displayed in the mobile device would be transformed into speech.

Once the output modality is selected the modality selection system converts the application output to the selected output modality (step 25). In the example of the Web search application in the preceding paragraph, a text to speech (TTS) system can be used to convert the text output of the search result to speech. The application output would then be transmitted to the user in the selected output modality (step 23). In an alternate embodiment the user interface used to transmit the application output in the selected output modality may also be determined by the system. For example, if the user has selected aural as the output modality, and the system has detected that the mobile device is moving at a speed greater than 3 mph, then the system may select a speaker phone component as the component to transmit the aural output, rather than the built-in speaker of the mobile device. Alternately, if the user has connected a headset, then the system may select the headset as the component to transmit the aural output. The system may include additional functionality to instruct the mobile device to undertake subsequent actions. For example the mobile device may connect the user to directory contact by call, may provide directions and navigation, and enable the user to compose text message or refine a search.

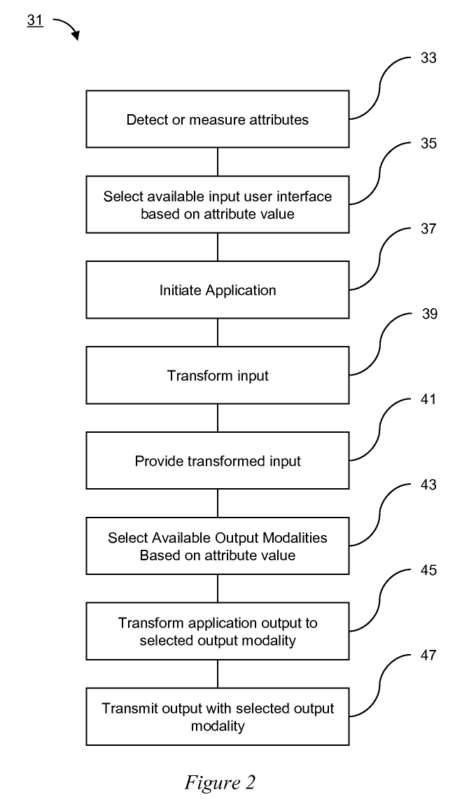

Illustrated in FIG. 2 is an alternate embodiment 31 of the method of the present subject matter. In this method, the system measures attributes of the mobile device (step 33) and the system selects an available input user interface based on the attribute value (step 35). The user then initiates the application using an available input user interface (step 37). The system transforms the input provided by the user into an input that can be processed by the application (step 39). The transformed input is provided to the application (step 41). The available output modalities are selected based on attributes value (step 43) and the system transforms the application output to the selected output modality (step 45). The output is then transmitted in the selected output modality through a selected output user interface. Using the example of a user driving an automobile, the attributes detected or measured in step 33 may include speed and that a headset is coupled to the mobile device. The available input user interface includes a microphone in the headset. The user may initiate the application by giving a voice command in step 37, for example “open directory.” The voice command would initiate the application and engage the system that transforms the voice input through the headset into a text to be used by the directory search (step 39). The user provides a voice input through the headset such as “search phone number Jones Michael,” and the system transforms the voice input into the text input that can be processed by the directory application (text). The system provides the text input to the directory search application (step 41). The system then determines that the best available output modality is voice (because of the speed) through the headset (because of the coupling of the headset) (step 43). The output is transmitted to the user in an aural modality through the headset, for example “Found Michael Jones' phone number. Dial?”

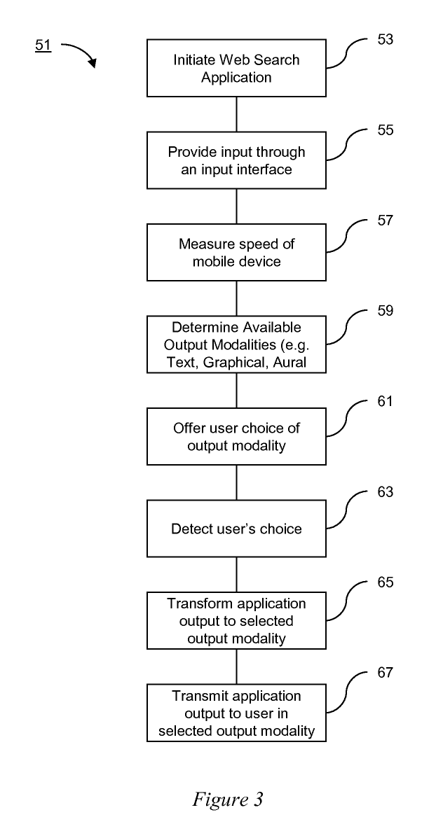

An example of a use of a modality selection system for searching the Web is illustrated in FIG. 3. The web searching method 51 starts with the initiation of the web search application (step 53). As described previously, this may be accomplished, among other ways, by clicking on an icon on the mobile device display or by voice command. In the case of a web search, the application may be a search engine that requires the input of words, phrases, or both perform the search. The user enters the input in through an input interface such as typing or speaking (step 55). In this example the modality selection system measures the attribute of speed of the mobile device (step 57). The modality selection system then determines the available output modalities (step 59). If the mobile device is stationary the available output modality may be text and graphics. If the mobile device is moving at a speed greater than 3 mph and available output modality may include voice. In the case of the mobile device that is moving at a speed of 30 mph, the modality selection system may offer the user a choice of output modalities in a predetermined set of modalities (step 61). The choice may include graphics, text, voice, sound, etc. if the value of the measured speed of the mobile device is 30 mph the choice would be offered using an oral modality. For example a voice message “please select voice or visual output” may be provided through the speakerphone. If the user is driving then the user should select voice from the choices offered using a voice command because of safety concerns. If the user is a passenger the user may select visual as the output modality, because there are no safety concerns for the passenger. If the user is a passenger who wants to share the output of the web search with the driver then the user may select an aural modality for the output. The modality selection system detects the user's choice (step 63) and if necessary converts the output of the application to the selected output modality (step 65). The modality selection system would then transmit the application output to the user in the selected output modality (step 67).

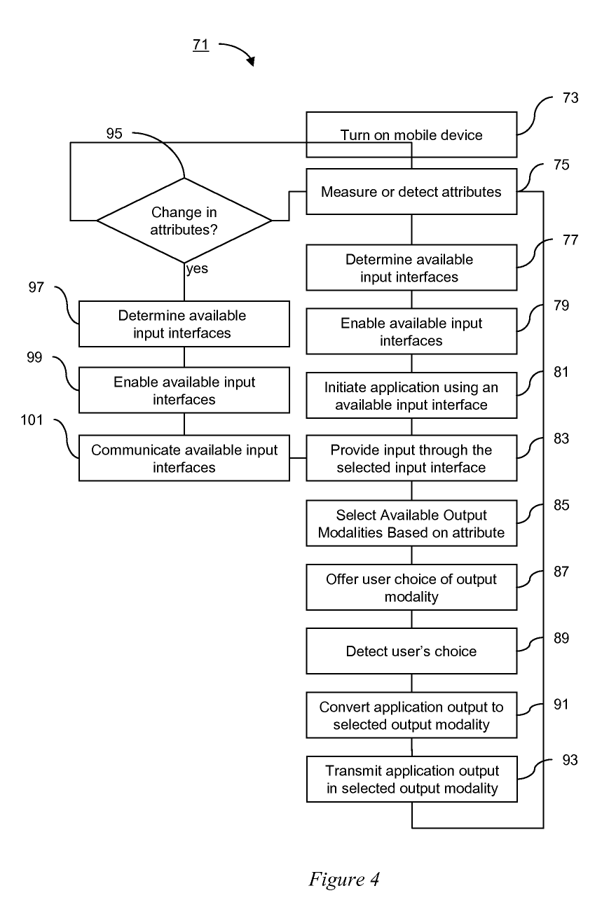

Illustrated in FIG. 4 is method 71 implemented by an alternate embodiment of a modality selection system. In this embodiment the available input interfaces and output modalities are determined by a component that measures certain attributes of the mobile device on a periodic basis. The method implemented by the modality selection system starts with the user turning on the mobile device (step 73). When the mobile device is turned on, the modality selection system measures or detects attributes of the mobile device (step 75). As stated above, the detection of the attributes may include speed of the mobile device, orientation of the mobile device, contact on surfaces of the mobile device and the like. The measurement or detection step 75 may occur on a periodic basis to adjust for changes in the attributes of the device. Based on the attributes detected in step 75, the modality selection system determines the available input user interfaces for applications in the mobile device (step 77). The modality selection system enables one or more input interfaces for the mobile device (step 79). For example, if the user is in an automobile moving at a speed greater than 3 mph the speed attribute is measured and and a microphone input interface is engaged. Thus, the user can interact with the mobile device and select applications using voice commands. If a user desires to initiate an application, the user can utilize any of the available input interfaces to initiate the application (step 81). For example a web search application may be initiated by the voice command “search the web.” The modality selection system 71 may provide a user override that overrides the automatic selection by the system. If the user is a driver, the user is likely to select voice as the input modality. If a user is a passenger in a moving car they may select text commands as the input modality for the application, thereby overwriting the selection of voice by the system.

Once an application has been initiated, the user will provide an input to the application through an available input interface (step 83). The modality selection system then determines the available output modalities based on measured attributes (step 85). The system may offer the user a choice of available output modalities (step 87), detect the user's choice (step 89), transform the output of the application to the selected output modality (step 91), and transmit the application output in the selected output modality (step 93). In this embodiment the system is continuously measuring the attributes, so that if it detects a change in the attributes, then a new choice can be made available to the user. This subsystem that measures or detects attributes in step 75 is continuously monitoring the attributes of the mobile device. If a change in attributes is detected in logic step 95 the system will determine the input interfaces made available as a result of the change in attributes (step 97), enable the new input interfaces (step 99) and communicate the available input interfaces to the user (step 101). The user can elect to change the input interface that is being used, and the system will provide input to the application through the newly selected interface.

An example of the implementation of the method in FIG. 4 is when the user utilizes the mobile device to conduct a Web search. The user may enter his/her automobile and use a keyboard as the input user interface while the automobile is stationary. When the user begins to travel in the automobile the change in the speed attribute is detected and measured. When the speed is greater than walking speed, the user is provided with a choice to change the user interface to voice commands. If the user elects to use voice commands the user can then conduct another Web search using voice commands and the system will provide an output using a voice modality. The reason the user would be given a choice is that in some cases the user may be a passenger in the automobile in which case the user may elect to use the keyboard as the input interface.

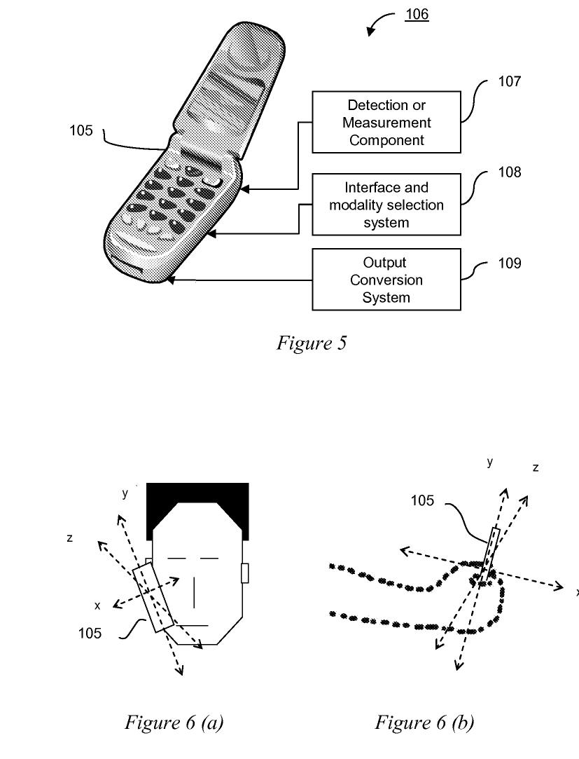

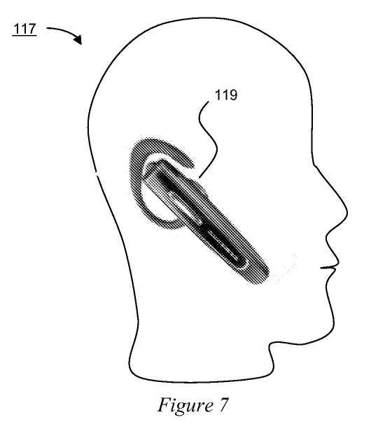

Illustrated in FIG. 5 is a mobile device 105 adapted with a modality selection system 106. The modality selection system 106 includes a detection or measurement component 107 to detect or measure attributes of the mobile device 105. The detection or measurement components may include sensors placed in close proximity to the speaker that can be used to determine whether the user is holding the mobile device against the user's ear (as illustrated in FIG. 6(a)), accelerometers and orientation sensors to determine if the user is holding the mobile device in front of user (as illustrated in FIG. 6(b)). The detection or measurement component may include logic to determine the input interface being utilized by the user. For example, if the user uses a keyboard to select the application, then the modality selection system may include the keyboard as an input user interface. Another detection or measuring component may include a location determination component such as a GPS system and a velocity measuring component. Another example of a detection or measurement component 93 is a component that detects whether a peripheral device is attached to the mobile device 105 (as illustrated in FIG. 7). In the case of headphones connected to the mobile device 105 the detection or measurement component may be as simple as a device that detects whether headphones are connected to an output jack of the mobile device 105, or whether Bluetooth enabled headphones are coupled to the mobile device 91.

The mobile device 105 adapted with a modality selection system 106 also includes an an input interface and output modality selection system 108. The input interface and output modality selection system 108 may include software that uses values measured by the detection or measuring component 107 to select from a plurality of available input interfaces and output modalities.

The mobile device 105 adapted with a modality selection system also includes an output conversion system 109. An example of an output conversion system 109 is a text to speech (TTS) system that transforms normal language text into speech. A TTS system simulates speech by splicing pieces of recorded speech stored in a database. A typical TTS system converts text that includes symbols (numbers, abbreviations etc.) into the equivalent of the written word. The TTS systems and assigns sound units to each word and marks the text into phrases clauses and sentences. The TTS then puts together the sound units into a sound output.

Illustrated in FIGS. 6(a) and 6(b) are representations of the orientations that may be measured by a detection or measurement component in a mobile device 105. The orientation of the device may be represented as values in a three-dimensional space (XY and Z axes). The modality selection system may select an output modality based on the orientation of the mobile device 103. For example in FIG. 6(a) based on the orientation of the mobile device 103 available modalities may be just sound. Alternately, the available modalities available in the orientation shown in FIG. 6(b) may include text, graphics and sound.

FIG. 7 illustrates a user 117 with the Bluetooth headphone 119. The Bluetooth headphone 119 may be detected by the detection or measurement component. If in addition the detection and measurement component detects that the mobile device is moving at a certain range of speeds that indicates that the user may be driving, the output modalities may be limited to aural output.

The systems and methods for selecting an output modality in a mobile device may be implemented in a variety of mobile devices, such as wireless devices used in a variety of networks as described below.

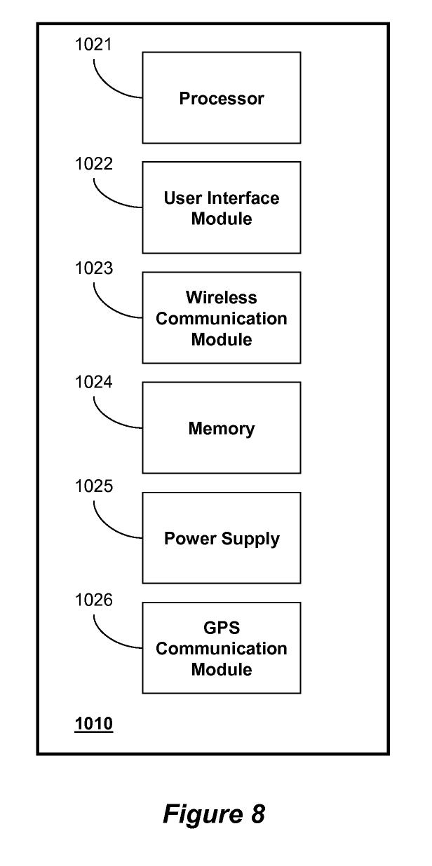

FIG. 8 illustrates an example wireless device 1010 that may be used in connection with an embodiment. References will also be made to other figures of the present disclosure as appropriate. For example, device 102 may be a wireless device of the type described in regard to FIG. 8, and may have some, all, or none of the components and modules described in regard to FIG. 8. It will be appreciated that the components and modules of wireless device 1010 illustrated in FIG. 8 are illustrative, and that any number and type of components and/or modules may be present in wireless device 1010. In addition, the functions performed by any or all of the components and modules illustrated in FIG. 8 may be performed by any number of physical components. Thus, it is possible that in some embodiments the functionality of more than one component and/or module illustrated in FIG. 8 may be performed by any number or types of hardware and/or software.

Processor 1021 may be any type of circuitry that performs operations on behalf of wireless device 1010. In one embodiment, processor 1021 executes software (i.e., computer readable instructions stored in a computer readable medium) that may include functionality related to constructing, transmitting, receiving messages such as SMS and MMS messages, operating an address book, and determining alternate addresses, for example. User interface module 1022 may be any type or combination of hardware and/or software that enables a user to operate and interact with wireless device 1010, in one embodiment, to compose and read messages. For example, user interface module 1022 may include a display, physical and “soft” keys, voice recognition and text to speech software or thin clients that connect to respective speech servers, microphone, speaker and the like. Wireless communication module 1023 may be any type or combination of hardware and/or software that enables wireless device 1010 to communicate with, for example, network 103 or any other type of wireless communications network. Memory 1024 enables wireless device 1010 to store information, such as an address book, contacts information, or the like. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010.

GPS communication module 1026 may be any type or combination of hardware and/or software that enables wireless device 1010 to communicate with GPS location equipment. In one embodiment, wireless communication module 1023 may perform the functions of GPS communication module 1026. In an alternative embodiment, GPS communication module 1026 may be separate from wireless communication module 1023.

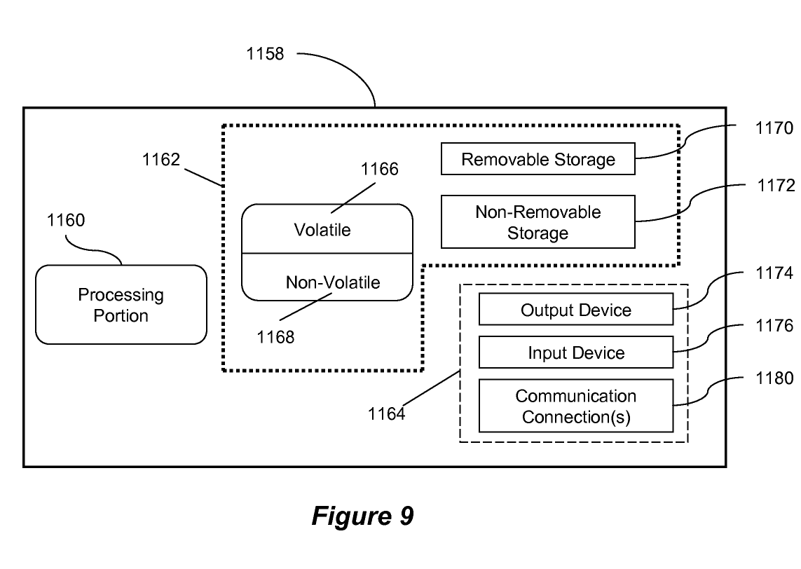

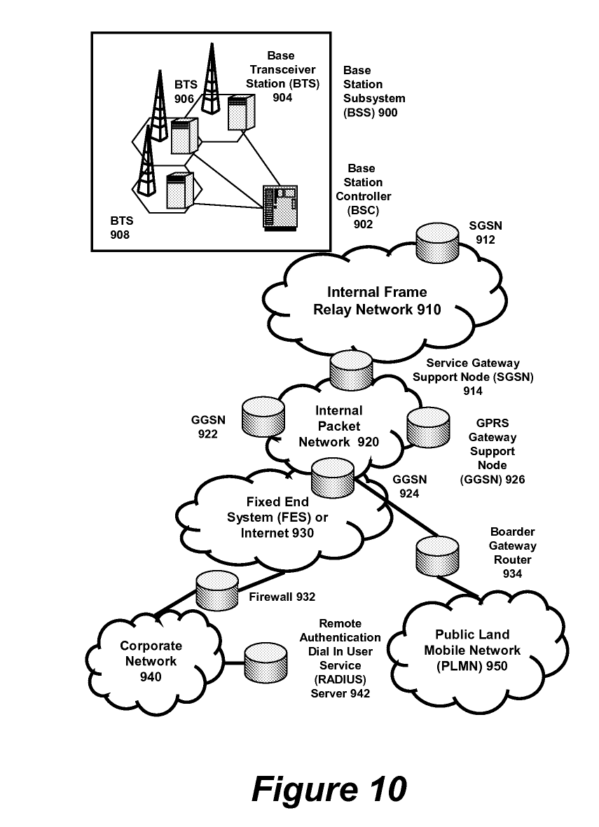

FIG. 9 is a block diagram of an example processor 1158 which may be employed in any of the embodiments described herein, including as one or more components of a communications device such as device 102, which may be a wireless communications device, as one or more components of communications network equipment or related equipment, such as any component of network 103, and/or as one or more components of any third party system or subsystems that may implement any portion of the subject matter described herein. It is emphasized that the block diagram depicted in FIG. 9 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof.

The processor 1158 comprises a processing portion 1160, a memory portion 1162, and an input/output portion 1164. The processing portion 560, memory portion 562, and input/output portion 1164 are coupled together (coupling not shown in FIG. 9) to allow communications between these portions. The input/output portion 1164 is capable of providing and/or receiving components utilized to, for example, transmit/receive messages and/or transmit/receive data for an address book or contact list.

The processor 1158 can be implemented as a client processor and/or a server processor. In a basic configuration, the processor 1158 may include at least one processing portion 1160 and memory portion 1162. The memory portion 1162 can store any information utilized in conjunction with transmitting, receiving, and/or processing messages, contact information and numbers, determining alternate contacts, etc. For example, as described above, the memory portion is capable of storing an address book and software capable of operating the address book and determining alternate numbers. Depending upon the exact configuration and type of processor, the memory portion 1162 can be volatile (such as RAM) 1166, non-volatile (such as ROM, flash memory, etc.) 1168, or a combination thereof. The processor 1158 can have additional features/functionality. For example, the processor 1158 can include additional storage (removable storage 1170 and/or non-removable storage 1172) including, but not limited to, magnetic or optical disks, tape, flash, smart cards or a combination thereof. Computer storage media, such as memory and storage elements 1162, 1170, 1172, 1166, and 1168, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 1158. Any such computer storage media may be part of the processor 1158.

The processor 1158 can also contain the communications connection(s) 1180 that allow the processor 1158 to communicate with other devices, for example through network 103. Communications connection(s) 1180 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer readable media as used herein includes both storage media and communication media. The processor 1158 also can have input device(s) 1176 such as keyboard, keypad, mouse, pen, voice input device, touch input device, etc. Output device(s) 1174 such as a display, speakers, printer, etc. also can be included.

Network 103 may comprise any appropriate telephony radio network, or any other type of communications network, or any combination thereof. The following description sets forth some exemplary telephony radio networks, such as the global system for mobile communications (GSM), and non-limiting operating environments. The below-described operating environments should be considered non-exhaustive, however, and thus the below-described network architectures merely show how IP cellular broadcast may be used with stationary and non-stationary network structures and architectures. It can be appreciated, however, that systems for providing user names for network addresses such as those described herein can be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3G services, such as Universal Mobile Telephone System (UMTS), Frequency Division Duplexing (FDD) and Time Division Duplexing (TDD), High Speed Packet Data Access (HSPDA), cdma2000 1× Evolution Data Optimized (EVDO), Code Division Multiple Access-2000 (cdma2000 3×), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4G Services such as Long Term Evolution (LTE), etc., as well as to other network services that become available in time. In this regard, the techniques of the utilization of SMS, MMS, and/or cellular broadcast can be applied independently of the method of data transport, and do not depend on any particular network architecture, or underlying protocols.

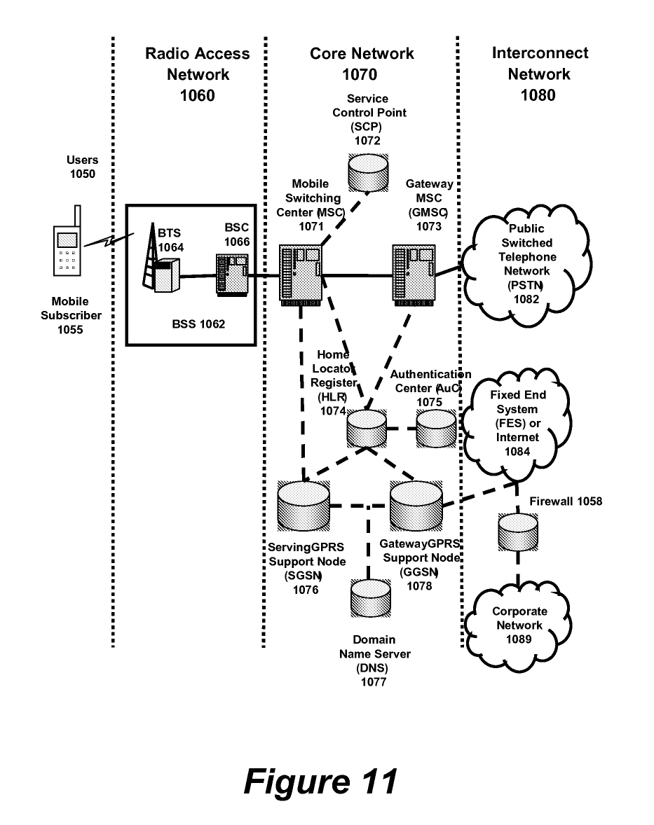

FIG. 11 depicts an overall block diagram of an exemplary packet-based mobile cellular network environment, such as a GPRS network, in which systems providing user names for network addresses such as those described herein can be practiced. In an example configuration, network 103 may be encompassed by the network environment depicted in FIG. 11. In such an environment, there may be a plurality of Base Station Subsystems (BSS) 900 (only one is shown), each of which comprises a Base Station Controller (BSC) 902 serving a plurality of Base Transceiver Stations (BTS) such as BTSs 904, 906, and 908. BTSs 904, 906, 908, etc. are the access points where users of packet-based mobile devices (e.g., device 102) become connected to the wireless network. In exemplary fashion, the packet traffic originating from user devices (e.g., device 102 and device 104) may be transported via an over-the-air interface to a BTS 908, and from the BTS 908 to the BSC 902. Base station subsystems, such as BSS 900, may be a part of internal frame relay network 910 that can include Service GPRS Support Nodes (SGSN) such as SGSN 912 and 914. Each SGSN may be connected to an internal packet network 920 through which a SGSN 912, 914, etc. may route data packets to and from a plurality of gateway GPRS support nodes (GGSN) 922, 924, 926, etc. As illustrated, SGSN 914 and GGSNs 922, 924, and 926 may be part of internal packet network 920. Gateway GPRS serving nodes 922, 924 and 926 may provide an interface to external Internet Protocol (IP) networks, such as Public Land Mobile Network (PLMN) 950, corporate intranets 940, or Fixed-End System (FES) or the public Internet 930. As illustrated, subscriber corporate network 940 may be connected to GGSN 924 via firewall 932; and PLMN 950 may be connected to GGSN 924 via boarder gateway router 934. The Remote Authentication Dial-In User Service (RADIUS) server 942 may be used for caller authentication when a user of a mobile cellular device calls corporate network 940.

Generally, there can be four different cell sizes in a GSM network, referred to as macro, micro, pico, and umbrella cells. The coverage area of each cell is different in different environments. Macro cells may be regarded as cells in which the base station antenna is installed in a mast or a building above average roof top level. Micro cells are cells whose antenna height is under average roof top level. Micro-cells may be typically used in urban areas. Pico cells are small cells having a diameter of a few dozen meters. Pico cells may be used mainly indoors. On the other hand, umbrella cells may be used to cover shadowed regions of smaller cells and fill in gaps in coverage between those cells.

FIG. 11 illustrates an architecture of a typical GPRS network segmented into four groups: users 1050, radio access network 1060, core network 1070, and interconnect network 1080. Users 1050 may comprise a plurality of end users (though only mobile subscriber 1055 is shown in FIG. 11). In an example embodiment, the device depicted as mobile subscriber 1055 may comprise device 102 and/or device 104. Radio access network 1060 comprises a plurality of base station subsystems such as BSSs 1062, which include BTSs 1064 and BSCs 1066. Core network 1070 comprises a host of various network elements. As illustrated here, core network 1070 may comprise Mobile Switching Center (MSC) 1071, Service Control Point (SCP) 1072, gateway MSC 1073, SGSN 1076, Home Location Register (HLR) 1074, Authentication Center (AuC) 1075, Domain Name Server (DNS) 1077, and GGSN 1078. Interconnect network 1080 may also comprise a host of various networks and other network elements. As illustrated in FIG. 11, interconnect network 1080 comprises Public Switched Telephone Network (PSTN) 1082, Fixed-End System (FES) or Internet 1084, firewall 1088, and Corporate Network 1089.

A mobile switching center may be connected to a large number of base station controllers. At MSC 1071, for instance, depending on the type of traffic, the traffic may be separated in that voice may be sent to Public Switched Telephone Network (PSTN) 1082 through Gateway MSC (GMSC) 1073, and/or data may be sent to SGSN 1076, which then sends the data traffic to GGSN 1078 for further forwarding.

When MSC 1071 receives call traffic, for example, from BSC 1066, it may send a query to a database hosted by SCP 1072. The SCP 1072 may process the request and may issue a response to MSC 1071 so that it may continue call processing as appropriate.

The HLR 1074 may be a centralized database for users to register to the GPRS network. HLR 1074 may store static information about the subscribers such as the International Mobile Subscriber Identity (IMSI), subscribed services, and a key for authenticating the subscriber. HLR 1074 may also store dynamic subscriber information such as the current location of the mobile subscriber. HLR 1074 may also serve to intercept and determine the validity of destination numbers in messages sent from a device, such as mobile subscriber 1055, as described herein. Associated with HLR 1074 may be AuC 1075. AuC 1075 may be a database that contains the algorithms for authenticating subscribers and may include the associated keys for encryption to safeguard the user input for authentication.

In the following, depending on context, the term “mobile subscriber” sometimes refers to the end user and sometimes to the actual portable device, such as device 102, used by an end user of the mobile cellular service. When a mobile subscriber turns on his or her mobile device, the mobile device may go through an attach process by which the mobile device attaches to an SGSN of the GPRS network. In FIG. 11, when mobile subscriber 1055 initiates the attach process by turning on the network capabilities of the mobile device, an attach request may be sent by mobile subscriber 1055 to SGSN 1076. The SGSN 1076 queries another SGSN, to which mobile subscriber 1055 was attached before, for the identity of mobile subscriber 1055. Upon receiving the identity of mobile subscriber 1055 from the other SGSN, SGSN 1076 may request more information from mobile subscriber 1055. This information may be used to authenticate mobile subscriber 1055 to SGSN 1076 by HLR 1074. Once verified, SGSN 1076 sends a location update to HLR 1074 indicating the change of location to a new SGSN, in this case SGSN 1076. HLR 1074 may notify the old SGSN, to which mobile subscriber 1055 was attached before, to cancel the location process for mobile subscriber 1055. HLR 1074 may then notify SGSN 1076 that the location update has been performed. At this time, SGSN 1076 sends an Attach Accept message to mobile subscriber 1055, which in turn sends an Attach Complete message to SGSN 1076.

After attaching itself with the network, mobile subscriber 1055 may then go through the authentication process. In the authentication process, SGSN 1076 may send the authentication information to HLR 1074, which may send information back to SGSN 1076 based on the user profile that was part of the user's initial setup. The SGSN 1076 may then send a request for authentication and ciphering to mobile subscriber 1055. The mobile subscriber 1055 may use an algorithm to send the user identification (ID) and password to SGSN 1076. The SGSN 1076 may use the same algorithm and compares the result. If a match occurs, SGSN 1076 authenticates mobile subscriber 1055.

Next, the mobile subscriber 1055 may establish a user session with the destination network, corporate network 1089, by going through a Packet Data Protocol (PDP) activation process. Briefly, in the process, mobile subscriber 1055 may request access to the Access Point Name (APN), for example, UPS.com, and SGSN 1076 may receive the activation request from mobile subscriber 1055. SGSN 1076 may then initiate a Domain Name Service (DNS) query to learn which GGSN node has access to the UPS.com APN. The DNS query may be sent to the DNS server within the core network 1070, such as DNS 1077, which may be provisioned to map to one or more GGSN nodes in the core network 1070. Based on the APN, the mapped GGSN 1078 can access the requested corporate network 1089. The SGSN 1076 may then send to GGSN 1078 a Create Packet Data Protocol (PDP) Context Request message that contains necessary information. The GGSN 1078 may send a Create PDP Context Response message to SGSN 1076, which may then send an Activate PDP Context Accept message to mobile subscriber 1055.

Once activated, data packets of the call made by mobile subscriber 1055 may then go through radio access network 1060, core network 1070, and interconnect network 1080, in a particular fixed-end system, or Internet 1084 and firewall 1088, to reach corporate network 1089.

Thus, network elements that can invoke the functionality of message systems and methods for providing user names for network addresses such as those described herein can include but are not limited to Gateway GPRS Support Node tables, Fixed End System router tables, firewall systems, VPN tunnels, and any number of other network elements as required by the particular digital network.

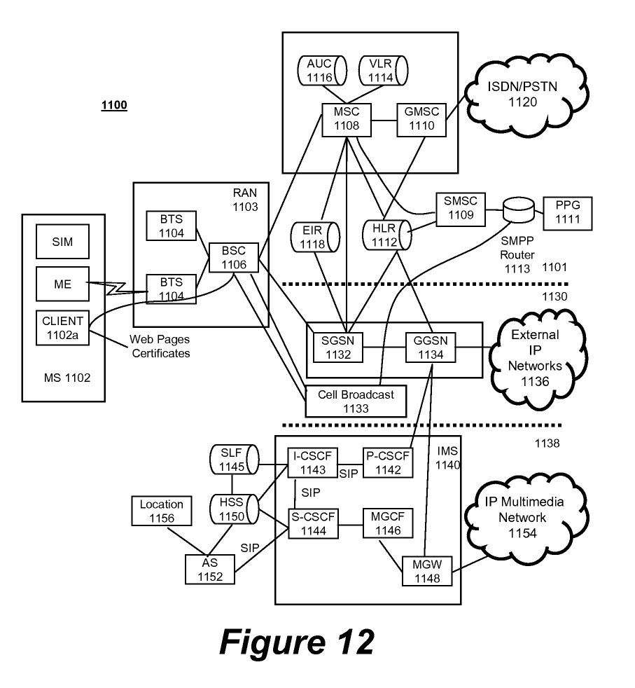

FIG. 12 illustrates another exemplary block diagram view of a GSM/GPRS/IP multimedia network architecture 1100 in which systems providing user names for network addresses such as those described herein can be incorporated. As illustrated, architecture 1100 of FIG. 12 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile telephone or a laptop computer (e.g., device 102) that is used by mobile subscribers, with a Subscriber identity Module (SIM). The SIM includes an International Mobile Subscriber Identity (IMSI), which is a unique identifier of a subscriber. The BTS 1104 may be physical equipment, such as a radio tower, that enables a radio interface to communicate with the MS. Each BTS may serve more than one MS. The BSC 1106 may manage radio resources, including the BTS. The BSC may be connected to several BTSs. The BSC and BTS components, in combination, are generally referred to as a base station (BSS) or radio access network (RAN) 1103.

The GSM core network 1101 may also include a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 may perform a switching function for the network. The MSC may also perform other functions, such as registration, authentication, location updating, handovers, and call routing. The GMSC 1110 may provide a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 is a database that may contain administrative information regarding each subscriber registered in a corresponding GSM network. Such information may also include address book data and/or message forwarding preferences for each subscriber. The HLR 1112 may also contain the current location of each MS. The VLR 1114 may be a database that contains selected administrative information from the HLR 1112. The VLR may contain information necessary for call control and provision of subscribed services for each MS currently located in a geographical area controlled by the VLR. The VLR may also contain address book data and/or message forwarding preferences for each subscriber. The HLR 1112 and the VLR 1114, together with the MSC 1108, may provide the call routing and roaming capabilities of GSM, as well as message forwarding functionality. The AuC 1116 may provide the propertys needed for authentication and encryption functions. Such propertys allow verification of a subscriber's identity. The EIR 1118 may store security-sensitive information about the mobile equipment.

A Short Message Service Center (SMSC) 1109 allows one-to-one short message service (SMS), or multimedia message service (MMS), messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 may be provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, short message service (SMS), and multimedia message service (MMS), the MS may first register with the network to indicate its current location by performing a location update and IMSI attach procedure. The MS 1102 may send a location update including its current location information to the MSC/VLR, via the BTS 1104 and the BSC 1106. The location information may then be sent to the MS's HLR. The HLR may be updated with the location information received from the MSC/VLR. The location update may also be performed when the MS moves to a new location area. Typically, the location update may be periodically performed to update the database as location updating events occur.

The GPRS network 1130 may be logically implemented on the GSM core network architecture by introducing two packet-switching network nodes, a serving GPRS support node (SGSN) 1132, a cell broadcast and a Gateway GPRS support node (GGSN) 1134. The SGSN 1132 may be at the same hierarchical level as the MSC 1108 in the GSM network. The SGSN may control the connection between the GPRS network and the MS 1102. The SGSN may also keep track of individual MS's locations and security functions and access controls.

A Cell Broadcast Center (CBC) 1133 may communicate cell broadcast messages that are typically delivered to multiple users in a specified area. Cell Broadcast is one-to-many geographically focused service. It enables messages to be communicated to multiple mobile telephone customers who are located within a given part of its network coverage area at the time the message is broadcast.

The GGSN 1134 may provide a gateway between the GPRS network and a public packet network (PDN) or other IP networks 1136. That is, the GGSN may provide interworking functionality with external networks, and set up a logical link to the MS through the SGSN. When packet-switched data leaves the GPRS network, it may be transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services may be used in parallel. The MS may operate in one three classes: class A, class B, and class C. A class A MS may attach to the network for both GPRS services and GSM services simultaneously. A class A MS may also support simultaneous operation of GPRS services and GSM services. For example, class A mobiles may receive GSM voice/data/SMS calls and GPRS data calls at the same time.

A class B MS may attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1130 may be designed to operate in three network operation modes (NOM1, NOM2 and NOM3). A network operation mode of a GPRS network may be indicated by a property in system information messages transmitted within a cell. The system information messages may direct a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while receiving data and vice versa.

The IP multimedia network 1138 was introduced with 3GPP Release 5, and may include an IP multimedia subsystem (IMS) 1140 to provide rich multimedia services to end users. A representative set of the network entities within the IMS 1140 are a call/session control function (CSCF), a media gateway control function (MGCF) 1146, a media gateway (MGW) 1148, and a master subscriber database, called a home subscriber server (HSS) 1150. The HSS 1150 may be common to the GSM core network 1101, the GPRS network 1130 as well as the IP multimedia network 1138.

The IP multimedia system 1140 may be built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 may forward session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

The I-CSCF 1143 forms an entrance to a home network and hides the inner topology of the home network from other networks and provides flexibility for selecting an S-CSCF. The I-CSCF 1143 may contact a subscriber location function (SLF) 1145 to determine which HSS 1150 to use for the particular subscriber, if multiple HSSs 1150 are present. The S-CSCF 1144 may perform the session control services for the MS 1102. This includes routing originating sessions to external networks and routing terminating sessions to visited networks. The S-CSCF 1144 may also decide whether an application server (AS) 1152 is required to receive information on an incoming SIP session request to ensure appropriate service handling. This decision is based on information received from the HSS 1150 (or other sources, such as an application server 1152). The AS 1152 may also communicate to a location server 1156 (e.g., a Gateway Mobile Location Center (GMLC)) that provides a position (e.g., latitude/longitude coordinates) of the MS 1102.

The HSS 1150 may contain a subscriber profile and keep track of which core network node is currently handling the subscriber. It may also support subscriber authentication and authorization functions (AAA). In networks with more than one HSS 1150, a subscriber location function provides information on the HSS 1150 that contains the profile of a given subscriber.

The MGCF 1146 may provide interworking functionality between SIP session control signaling from the IMS 1140 and ISUP/BICC call control signaling from the external GSTN networks (not shown.) It may also control the media gateway (MGW) 1148 that provides user-plane interworking functionality (e.g., converting between AMR- and PCM-coded voice.) The MGW 1148 may also communicate with other IP multimedia networks 1154.

While example embodiments systems and methods providing user names for network addresses such as those described herein have been described in connection with various computing devices/processors, the underlying concepts can be applied to any computing device, processor, or system capable of implementing the systems and methods for providing user names for network addresses described. The various techniques described herein can be implemented in connection with hardware or software or, where appropriate, with a combination of both. Thus, the methods and apparatuses for the systems and methods for providing user names for network addresses, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for a system for providing user names for network addresses. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems for providing user names for network addresses as described herein can also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus a message forwarding system. When implemented on a general-purpose processor, the program code combines with the processor to provide a unique apparatus that operates to invoke the functionality of a message forwarding system. Additionally, any storage techniques used in connection with a message forwarding system can invariably be a combination of hardware and software.

While the systems and methods for providing user names for network addresses have been described in connection with the various embodiments of the various figures, it is to be understood that other similar embodiments can be used or modifications and additions can be made to the described embodiments for performing the same function message forwarding without deviating from the described systems and methods. For example, one skilled in the art will recognize that a system providing user names for network addresses as described in the present application may apply to any environment, whether wired or wireless, and may be applied to any number of such devices connected via a communications network and interacting across the network. Therefore, systems providing user names for network addresses such as those described herein should not be limited to any single embodiment, but rather should be construed in breadth and scope in accordance with the appended claims. These and other changes can be made to the invention in light of the above detailed description. In general, in the following claims, the terms used should not be construed to limit the invention to the specific embodiments disclosed in the specification and the claims, but should be construed to include all networked digital messaging systems that operate under the claims. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

What is claimed:

1. A method for selecting an output modality for an application in a mobile device comprising:
detecting at least one attribute of the mobile device;
initiating an application in mobile device;
providing an input to the application; and
automatically identifying available modalities for the output of the application based on the attribute.
selecting a preferred output modality from the available modalities.

2. The method of claim 1 wherein said detecting step comprises detecting at least one attribute of the mobile device using a component of mobile device.

3. The method of claim 1 wherein said detecting step comprises detecting how the user is interfacing with the mobile device.

4. The method of claim 3 wherein the step of detecting how the user is interfacing with the mobile device comprises one from among a group comprising detecting whether the user is interfacing with the mobile device using a microphone incorporated into the mobile device; detecting whether the mobile device is being held against the user's ear; detecting whether the mobile device is being held in front of the user; detecting whether the user is using a keyboard on the mobile device; and detecting whether a headset is coupled to the mobile device.

5. The method of claim 2 wherein the component of the mobile device comprises one from among a group comprising: an input modality detector; at least one contact sensor on the mobile device; at least one speed sensor on the mobile device; at least one accelerometer on the mobile device; and at least one attitude sensor on the mobile device.

6. The method of claim 1 wherein the attribute comprises at least one from among a group comprising speed of the mobile device; attachment of a peripheral component; type of application; and the type of input user interface.

7. The method of claim 1 wherein the selected output modality comprises at least one selected from the group comprising; sound, visual; and hepatic.

8. The method of claim 1 wherein the transforming step comprises rendering textual information into speech using a text to speech system.

9. The method of claim 1 further comprising providing the user with a list of available input interfaces based on the value of a detected or measured attribute.

10. The method of claim 1 further comprising communicating the output of the application in the selected output modality using at least one component associated with the mobile device selected from the group comprising: a broadcast speaker, a telephone speaker, a graphical display in the mobile device, a peripheral graphical display connected to the mobile device; and a peripheral speaker connected to the mobile device.

11. A mobile device that automatically select the output modality of an application based on attributes of the mobile device comprising:
a component for detecting the attributes that provides a value for each detected attribute;
means for selecting an output modality of the mobile device based on the values of the detected attributes;
means for transforming the output of the application to the selected output modality; and
a plurality of output interfaces;
means for communicating to the user the output of the application through one of plurality of output interfaces in the selected output modality.

12. The mobile device of claim 11 wherein the components for detecting the attributes comprises a component selected from among the group comprising an input interface detector; at least one contact sensor on the mobile device; at least one speed sensor on the mobile device; at least one accelerometer on the mobile device; and at least one attitude sensor on the mobile device.

13. The mobile device of claim 11 wherein the selected output modality comprises at least one selected from the group comprising; sound; visual; and hepatic.

14. The mobile device of claim 11 further comprising means for providing user with a choice of an output modality an output interface.

15. The mobile device of claim 11 wherein the output interfaces comprise at least one interface selected from the group comprising a speakerphone, a telephone speaker incorporated into the mobile device, a graphical display in the mobile device, a peripheral graphical display connected to the mobile device, a peripheral speaker connected to the mobile device, and a pico projector incorporated into the mobile device.

16. Computer readable medium executable by a central processing unit in a mobile device having at least one input interface and at least one output interface comprising instructions to:
detect an attribute of the mobile device;
select an output modality based on the attribute;
interact with an application in the mobile device; and
transform the output of the application to the selected output modality.

17. The computer readable medium of claim 16 wherein said instructions to detect an attribute of the mobile device comprises instructions to detect at least one attribute from among a group of attributes comprising speed of the mobile device; attachment of a peripheral component; type of application; and the type of input user interface.

18. The computer readable medium of claim 16 wherein the instruction to select an output modality based on an attribute comprises instructions to select an output modality from among a group of modalities comprising sound, visual, and hepatic.

19. The computer readable medium of claim 16 further comprising instructions to select an input interface based on the attribute.

20. The computer readable medium of claim 16 further comprising instructions to communicate the output of the application through an output interface comprising at least one output interface selected from the group comprising a speaker phone, a telephone speaker incorporated into the mobile device, a graphical display in the mobile device, a peripheral graphical display connected to the mobile device, a peripheral speaker connected to the mobile device, and a pico projector incorporated into the mobile device.
